(19) United States
(12) Patent Application Publication
(10) Pub. No.: US 2008/0031300 A1
(43) Pub. Date: Feb. 7, 2008

(54) Inclined Pump Beam Radiation Emitter

(75) Inventors: Johan Rothman, Grenoble (FR); Emmanuel Picard, St Martin d'Uriage (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/579,508

(22) PCT Filed: May 2, 2005
(86) PCT No.: PCT/FR05/50292

§ 371 Date: Nov. 3, 2006

(30) Foreign Application Priority Data
May 4, 2004 (FR) 0404803

(51) Int. Cl. H01S 3/091; H01S 3/093

(52) U.S. Cl. 372/72

(57) ABSTRACT

A device for emitting radiation by optical pumping. A mechanism emits light, and includes a first resonant cavity having a first input mirror and an output mirror. An optical pumping device emits a pumping beam from the first cavity, the normal to the input surface of the resonant cavity is inclined at an angle θ with respect to the direction of propagation of the pumping beam. A mechanism forms a second resonant cavity for the pumping beam, and includes a second input mirror forming the second cavity with the output mirror of the first cavity, and further includes an optical element, transparent to the pumping wavelength, between the first and second input mirrors.

### TECHNICAL FIELD AND PRIOR ART

The invention relates to the field of light emitting devices.

It relates in particular to the production of infrared light emitting devices capable of being used, for example, for the detection of gas and the sorting of plastics.

Such an emitting device can also be used to detect polluting gases in vehicle exhaust pipes.

The detection of the gas by optical means in the wavelength range of 3 to 5 μm provides a number of advantages:
the absorption lines are intense,
the absorption lines are, for the most significant gases, clearly separated in wavelength.

The difficulty of using this range of wavelengths is that there are few available sources that are sufficiently intense and directional.

Lasers based on quantum cascade effects are too expensive and very complex to produce.

Filtered filaments have low intensities but can be used in combination with synchronous detection.

However, they are too slow to allow for direct modulation and require mechanical modulation of the light, which is excessive and too fragile for most applications.

The use of CdHgTe-based resonant microcavities as a source was proposed by E. Hadji and E. Picard in document FR-0116116, with numerous advantages:
low cost,
low bulk,
adjustable wavelength with a narrow spectral width,
the source is fast enough for direct modulation.

The microcavity used in such an emitting device is shown diagrammatically in FIG. 1. An emitting layer 1 is sandwiched between two barrier layers 2 and two Bragg mirrors 3 and 4. The cavity rests on a substrate 5, for mechanical reasons.

The barrier layers 2 serve to create photocarriers by absorbing photons from a pump laser diode.

The IR emission is generated by the recombination of the photocarriers in the emitting layer 1.

The emission of the microcavity is determined in particular by the absorption of the pump laser diode. The thicknesses of the layers in the cavity are also adapted so that the cavity is resonant at the emission wavelength.

Typically, the thicknesses of the barriers 2 are such that around 60% of the pump light is absorbed in the cavity, thus limiting the emitted power of the emitting device.

FIG. 2 shows an example of a standard emitting system. A microcavity 6 is mounted on a mounting structure 7 that makes it possible to assemble the microcavity with pump means 8, for example a laser diode.

The production and operation of such microcavities are described in document FR-0116116.

Two phenomena limit the power emitted by these known devices.

A portion of the radiation of the pump laser diode is reflected by the cavity input mirror 6.

A portion of the optical power of the pump laser diode can therefore be reflected in this same diode, thus creating power instabilities. The reflected light represents a loss of intensity of the pump beams and thus causes a loss in the emission of the emitting device.

This reflected light can also cause instabilities in the pump diode 8. This problem can be solved by choosing a wavelength of the pump diode, which will be less reflected, with the disadvantage of an additional cost engendered by the development of a specific pump diode for each wavelength.

In addition, only a portion of the power of the pump diode is absorbed in the layer 1, due to the end thickness of the barrier layers 2.

### DESCRIPTION OF THE INVENTION

The invention proposes a system that makes it possible to optimise the emission of a light emitting device by optimising or improving the transmission of a pumping beam through an input mirror of the emitting device end/or the optimisation or the improvement of the absorption, in a resonant cavity of the emitting device, of a pumping beam of a pumping diode used to optically excite carriers in the emitting device.

According to a first aspect, the invention relates to a device for emitting radiation by optical pumping, including:
means for emitting light comprising a first resonant cavity having a first input mirror and an output mirror,
optical pumping means for emitting a pumping beam of the first cavity, the normal to the input surface of the resonant cavity being inclined with respect to the direction of propagation of the pumping beam of a non-zero angle θ, or comprising means or tilting means for forming a non-zero angle θ with respect to this propagation direction,
means for forming a second resonant cavity for the pumping beam, said means comprising a second input mirror forming said second cavity with the output mirror of the first cavity, characterised in that it comprises an optical element, transparent to the pumping wavelength, can be provided between the first and second input mirrors. This optical element makes it possible to optimise the length of the second cavity for a given pumping wavelength.

According to an embodiment, the resonant cavity is inclined at an angle θ so that the pumping beam is transmitted in the first cavity through the input surface with a transmission greater than 50%.

The mirrors can be Bragg or metallic mirrors.

The reflectivities R_{E} and R_{S} of the second input mirrors and of the output mirror at the wavelength of the pumping laser diode P preferably satisfy the condition:
R_{E}=R_{S} exp(−2αd/cos θ′),
where α is the absorption coefficient at the pumping wavelength, d is the absorbing thickness and θ′ is the angle of propagation with respect to the normal, of the light in an absorbing medium.

The absorption of the pumping beam in the second cavity can be greater than 50%.

The radiation is preferably emitted primarily according to the fundamental mode of the second resonant cavity.

The optical pumping means can advantageously comprise at least one VCSEL.

The radiation beam emitted by the first resonant cavity can have a diameter smaller than 200 μm.

The emission wavelength of the first cavity is, for example, at least partially between 2 μm and 10 μm.

The invention also relates to an optical device comprising a device as described above and an optical fibre coupled with the output of the first resonant cavity.

The invention therefore proposes various means for increasing the power emitted for a given power of a pumping diode, by optimising the transmission and/or the absorption of the beam of the pumping diode.

It also makes it possible to optimise this absorption in the case of an adjustable pumping laser wavelength.

The invention also proposes various means for assembling the pumping diode and the emitting device.

It relates to a support device comprising means for maintaining a non-zero angle θ, for example between 10° and 30°, between a direction of propagation of a pumping beam of a pumping means of a resonant cavity and a normal to a surface or to an input mirror of this cavity.

The invention therefore also relates to a device or a support for mounting a radiation emission device and optical pumping means for emitting a pumping beam, comprising:
means for maintaining said pumping means in the mounting device,
means for holding a radiation emission device, so that the normal to the input surface of these radiation emission means is inclined at an angle θ with respect to the direction of propagation of a pumping beam coming from said optical pumping means.

According to the invention, it is therefore possible to produce a device or a support comprising two surfaces, on which the pumping means and the emission means are intended to be mounted, these surfaces forming between themselves an angle θ. This support can be, for example, the growth substrate of a pumping VCSEL.

The means for holding the pumping means can comprise an excavation formed in the assembly device.

The excavation can have rotational symmetry about an axis parallel to a longitudinal axis of the assembly device.

In this case, an end surface of this assembly device can define a plane having a normal inclined at an angle θ with respect to this longitudinal axis.

The excavation can be inclined by a angle θ with respect to a longitudinal axis of the assembly device.

In this case, an end surface of this device defines a normal plane with respect to this longitudinal axis.

The invention therefore proposes various means for assembling a microcavity with laser pumping means, which make it possible to:

a) optimise the emission of the emitting device by optimising the absorption of the laser pump;

b) removing the instabilities in the pump due to the reflections of the pumping beam on the surface of the transmitter.

The angle θ makes it possible to avoid the reflection of the light of the pumping beam in the cavity, thus eliminating the instabilities in the pumping means.

The angle θ is preferably chosen so as to optimise the absorption of the pump when the wavelength is fixed.

### BRIEF DESCRIPTION OF THE FIGURES

FIGS. 1 and 2 show a device according to the prior art;

FIGS. 3 and 4 are transmission and absorption curves based on the angle of incidence of a pumping beam,

FIGS. 5 to 9 show various embodiments of the invention.

### DETAILED DESCRIPTION OF SPECIFIC EMBODIMENTS

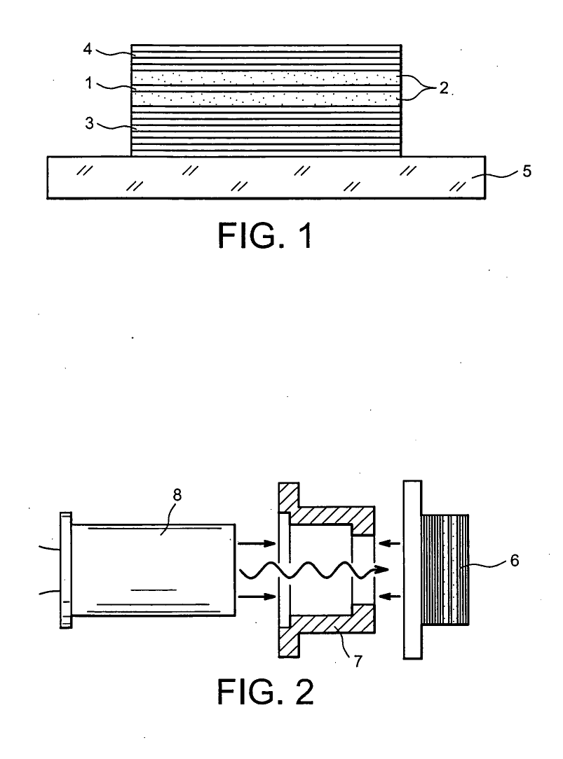

The invention applies to a coherent or non-coherent light emitting device, as, for example, shown in FIG. 1. Such a device is optically pumped with pumping means.

The emitting layer 1 is, for example, made of Cdₓ Hg₁₋ₓ Te (0.2≦x≦0.5), the barrier layers 2 of Cdₓ Hg₁₋ₓ Te with x=0.65, and the mirrors 3.4 of YF₃ZnS, or YF₃Si . . . .

The material of the emitting layer can therefore be Hg₁₋ₓCdₓTe. Other examples of materials that can be used are III-IV semiconductors (InAs₁₋ₓSbₓ, or Ga₁₋ₓInₓSb or Ga₁₋ₓInₓAs_{1-y}Sb_{y}) or IV-VI semiconductors (Pb₁₋ₓSnₓTe or Pb₁₋ₓSnₓSe).

A first embodiment of the invention relates to the optimisation of the absorption of the pumping beam by optimising or maximising the transmission of the pumping beam through the input mirror of a cavity such as that shown in FIG. 1.

The transmission of a Bragg mirror is dependent on the stack of layers of this mirror, the thicknesses and indices of these layers, the wavelength of the radiation as well as the angle of incidence of the radiation.

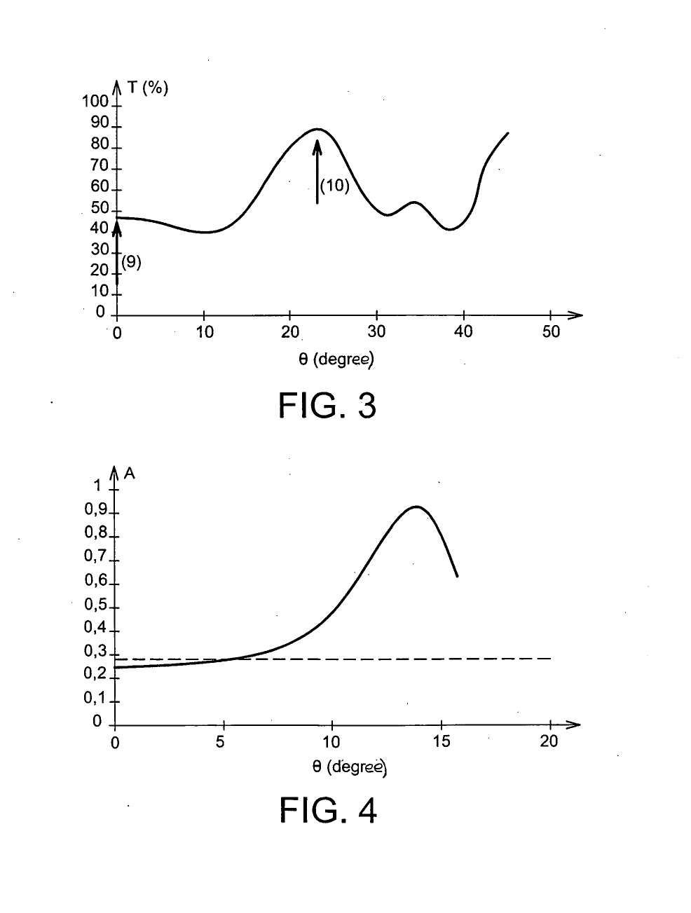

FIG. 3 shows the transmission of a Bragg mirror for a beam emitted by a pumping diode, with a wavelength λp=830 nm, according to the angle θ of incidence, i.e. the angle between the direction of propagation of the pumping beam and the normal to the input mirror of the cavity, said mirror being optimised for a maximum reflection at λₑₘᵢₛₛᵢₒₙ=3.3 μm (it concerns the wavelength, or the main wavelength of the beam emitted by the cavity).

The arrow 9 indicates the transmission at the normal angle of incidence θ=0°: T=45%.

A change in the angle of incidence increases the optical path between the interfaces of each Bragg mirror layer and makes it possible to change the transmission through this mirror.

A mirror that is optimised for a maximum reflection of the emitting device at an emission wavelength, λ_{E}, can thus be made as transparent as possible for the wavelength of the pumping laser diode. It is also possible to achieve such an optimisation if there is a type of mirror, at the input, other than a Bragg mirror.

Preferably, the angle θ is chosen so that the transmission of the pumping beam is at a maximum transmission, for example greater than 70% or 80% or 85%, as indicated by the arrow 10 of FIG. 3.

This choice also makes it possible to render the system less sensitive to the fluctuations created during production, with uncertainties on the angle of incidence or on the thicknesses of the layers in the mirror, and with the value of the pumping wavelength.

However, the angle θ can also be chosen so that the transmission T of the pumping beam is greater than 50%. In FIG. 3, this corresponds to an angle between around 13° and 29°.

In addition, by modifying the structure of the dielectric mirror, it is advantageously possible to transform the transmission curve so as to obtain a more square profile, i.e. with a transmission range greater than 50%, that is more uniform, while preserving the optimal reflectivity for the emission wavelength of the cavity.

According to another embodiment, the absorption of the pumping beam is optimised by creating resonance of said beam.

In this configuration, the power of the pumping laser diode absorbed in the cavity can be optimised as follows.

The angle of incidence is chosen to adjust an optical path of the beam coming from pumping means in the cavity defined by the input and output mirrors of the cavity, so that the cavity also becomes resonant for the wavelength of the pumping laser diode.

In the simple case of a homogeneous cavity, and disregarding the phase shift that may be caused by the mirrors, the angle θ of incidence is preferably chosen so that the following ratio k is whole:

$$k = \frac{2 ne cos {θ}^{′}}{{λ}_{p}} , \qquad ( 1 )$$

where n is the optical index in the cavity, e is the thickness of the cavity (measured perpendicularly to the plane of the mirrors), λₚ is the wavelength of the pump and θ′ is the angle of propagation, with respect to the normal to the input mirror of the cavity, of the light in the absorbing medium.

The reflectivity of the input 3 and output 4 mirrors (R_{E} and R_{S}, respectively) at the wavelength of the pumping laser diode λₚ can, in addition, be optimised for maximum absorption of the beams of the pumping laser diode in the cavity.

The resonant effect is optimal for maximal Rₛ, and:
R_{E}=R_{S} exp(−2αd/cos θ′) (2)
where α is the absorption coefficient and d is the absorbing thickness, measured perpendicularly to the planes of the mirrors and where θ′ has been defined above. For a non-maximal Rs, it is also possible to use this formula.

The optimisation can also be achieved with the constraint that the reflectivities Rₑ and Rₛ are not affected for the emission wavelength of the laser cavity.

Types of mirrors other than Bragg mirrors, for example, metallic mirrors, also make it possible to ensure high reflectivity for both the wavelength of the pump and the emission.

The optimisation can also be achieved by adapting the value of αd, for example by modifying the thickness of the absorbent (adaptation of d) or by choosing another material (adaptation of α).

FIG. 4 shows an example of absorption A in a cavity according to the angle of incidence θ, calculated for a cavity emitting at λ=3.3 μm and with (1−exp(−αd))=0.27, R_{E}=0.36 and R_{S}=0.90.

At θ=14°, we observe resonance with an absorption >90%, to be compared with the absorption in normal transmission, without reflection at the input and at the output, of 27%, indicated by the dotted line in FIG. 4. According to the invention, it is possible to establish, by selecting the angle of incidence, an absorption between, for example 40% or 50% and 90%.

A significant increase in absorbed power can thus be obtained.

In addition, this resonance makes it possible to use low thicknesses of absorbing layers, therefore cavities of low thickness. It is therefore possible to emit in the fundamental mode (n times more powerful than the mode of order n), which makes it possible to increase the efficacy of the cavity for the emission.

Thus, the efficacy of the emission can by optimised by increasing the absorption.

According to another embodiment, the transmission of the pumping laser diode is optimised by adjusting the angle of incidence (for good transmission through the input mirror of the emitting cavity, as explained above) and by optimising the absorption of the pumping beam by creating a second resonant cavity at the pumping wavelength.

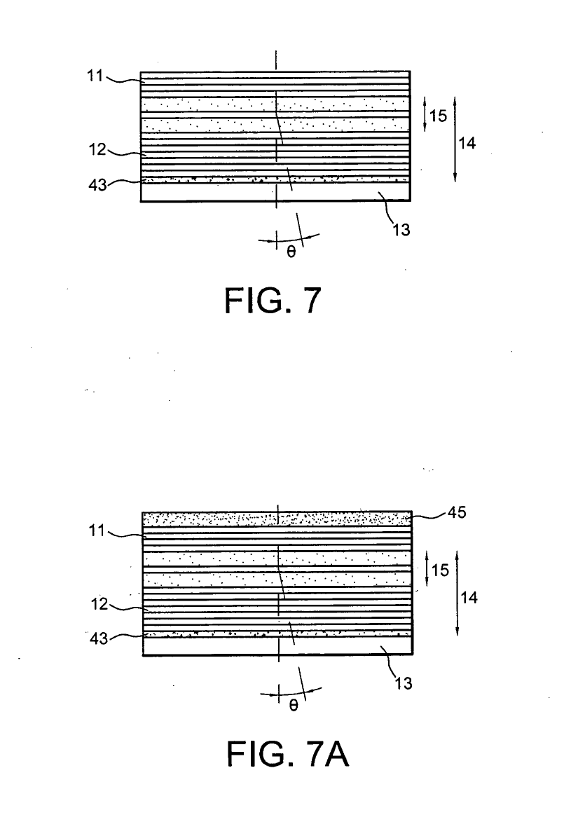

FIG. 7 shows an emitting device having two input mirrors 12, 13, on the pumping laser diode side, and one output mirror 11 on the emission side, forming two cavities.

A first emission cavity 15 is formed between the input Bragg mirror 12 and the output mirror 11.

The second cavity 14 is formed between the second input mirror 13 and the output mirror 11.

The angle of incidence θ and the wavelength λₚ of the pumping laser diode are adjusted so that:

a) the Bragg mirror 12 at the input of the cavity of the emitting device is as transparent as possible, at the wavelength λₚ and,

b) the cavity 14 formed between the output mirror 11 of the emitting device and the additional input mirror 13 form a resonant cavity for the wavelength λₚ of the pumping laser diode under incidence θ.

The input and output mirrors 11, 13 of cavity 14 for the pumping laser diode preferably satisfy the condition (2) of maximum absorption given above and can be Bragg or metallic mirrors.

This method makes it possible to optimise the transmission of the input mirror for the pumping beam and to optimise the efficacy of the latter for the pumping of the emitting cavity.

In addition, the use of distinct input mirrors for the pumping beam cavity and the emission cavity makes it easier to optimise the reflectivity of the input mirror 13 of the cavity of the pumping beam.

Moreover, the thickness of the cavity of the pumping laser diode, which is greater than that of the emitting cavity, makes it easier to obtain a resonance of the pump according to the angle and the wavelength λₚ of the pumping diode.

The resonance, in the cavity 14, of the pumping laser diode can be obtained by adding a thickness of a material of an optical element 43, transparent at the pumping wavelength λₚ, between the two input mirrors 12 and 13. It is therefore possible to adjust the length of the cavity 14. The angle θ is then chosen so as to optimise the transmission of the input mirror 12 of the emission cavity.

The efficacy of the device is also dependent on the divergence of the emission of the pumping laser diode. A minimal divergence is therefore preferable. An additional lens between the pumping laser diode and the emitting device can be used to this end in some cases, in particular for diodes emitting through the wafer.

It is also possible to add an additional mirror 45 to the output mirror 11, which is transparent at the emission wavelength and reflective at the pumping wavelength, so as to improve the resonance of the pumping beam (FIG. 7a).

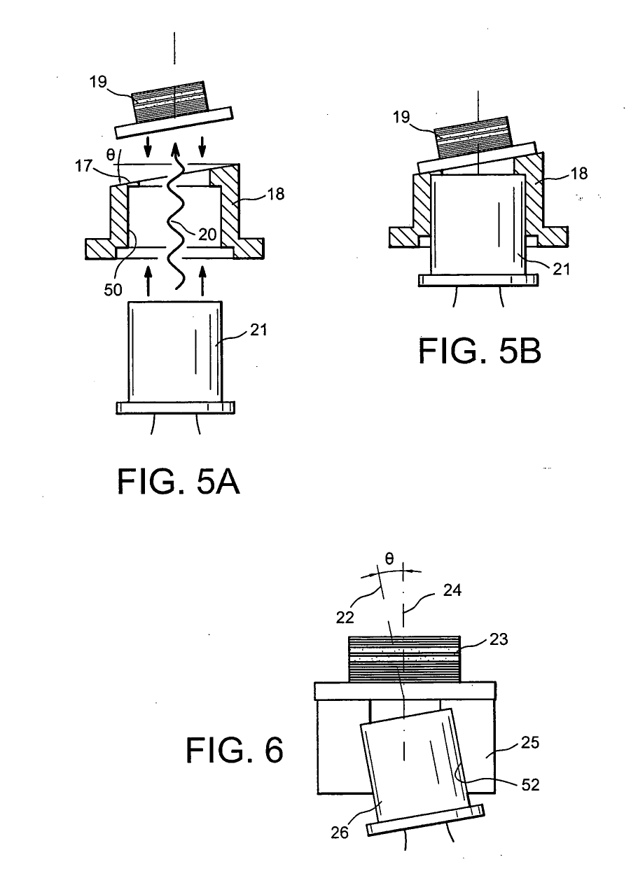

FIG. 5A shows an example of an embodiment of an assembly according to the invention. The emitting device 19 is bonded to the front surface of a mounting structure 18.

The pumping laser diode 21 is mounted in a hole or a cavity 50, which is cylindrical in this example, suitable for receiving this diode 21, on the rear side of the mounting structure, and is centred on the axis of the mounting structure.

The angle θ is defined on the front surface 17 of the mounting structure 18 and makes it possible to introduce the optimal angle between the emitting device 19 and the emission 20 of the pumping laser diode 21 that also comes into contact with the structure 18.

FIG. 5B shows the various assembled components.

FIG. 6 shows a second embodiment of an assembly, making it possible to introduce an optimal angle θ.

With respect to the first configuration, the angle θ is introduced by tilting the hole or 52 for mounting the pumping laser diode 26 in the rear surface of the mounting structure 25.

The emission of the pumping laser diode is in this case inclined according to an angle θ with respect to the axis of the mounting structure.

The emitting device 23 is bonded to the front surface of the mounting structure 25 with a normal to this emitting device parallel to the axis 24 of this mounting structure.

In this case, the emission lobe of the emitting device 23 is centred on the axis of the mounting structure.

This second embodiment has the advantage of facilitating the use of the light emitted by the emitting device.

For example, the coupling of the light in an optical fibre can in this case be achieved easily by a passive alignment, centred on the axis 24 of the mounting structure.

It is also possible to produce a support having two opposite surfaces, the pumping means and the emission means each being on one of these two surfaces, which form the angle θ therebetween.

In a third embodiment of an assembly of the emitting device with the pumping laser diode, it is possible to specifically use a VCSEL (Vertical Cavity Surface Emitting Laser) pumping laser diode, emitting by the rear surface.

This embodiment is shown in FIG. 8. In this embodiment, the emitting device 27 is transferred by plate directly onto the rear surface 28 of a VCSEL 29. The angle θ 30 between the normal to the emitting device 27 and the direction of emission of the VCSEL 29 is introduced by a polishing of the rear surface 28 of the VCSEL 29, performed either before or after the production of the VCSEL.

This embodiment provides numerous advantages over the first two mounting structures:
it makes it possible to produce a coupling between an emitting device 27 and pumping diodes, collectively.
the use of VCSEL emitting by the rear surface, of which the beam is coupled directly in the emitting device, of which the beam is directly coupled in the emitting device, makes it possible to minimise the divergence of the emission of the pumping diode, thus making the optimisation of the emission of the emitting device more effective, which is further reinforced by the choice of the angle θ. A lens for collimation of the emission of the pumping laser diode is not necessary.
the emission of the emitting device can then take place over a reduced surface, determined by the size of the optical beam of the pumping laser diode, and, secondly, by the diffusion length of the carriers in the cavity. The low divergence of the VCSEL and the proximity of the coupling make it possible to reduce the emission surface of the emitting device 27 to less than 100 μm in diameter. This size is comparable with the core of some optical fibres, thereby making direct and complete coupling of the light emitted in an optical fibre possible, without using additional optical components.

According to the invention, it is therefore possible to produce a device or a support comprising two surfaces, on which the pumping means and the emission means are intended to be mounted, these surfaces forming an angle θ therebetween. This support can be, for example, the growth substrate of a pumping VCSEL.

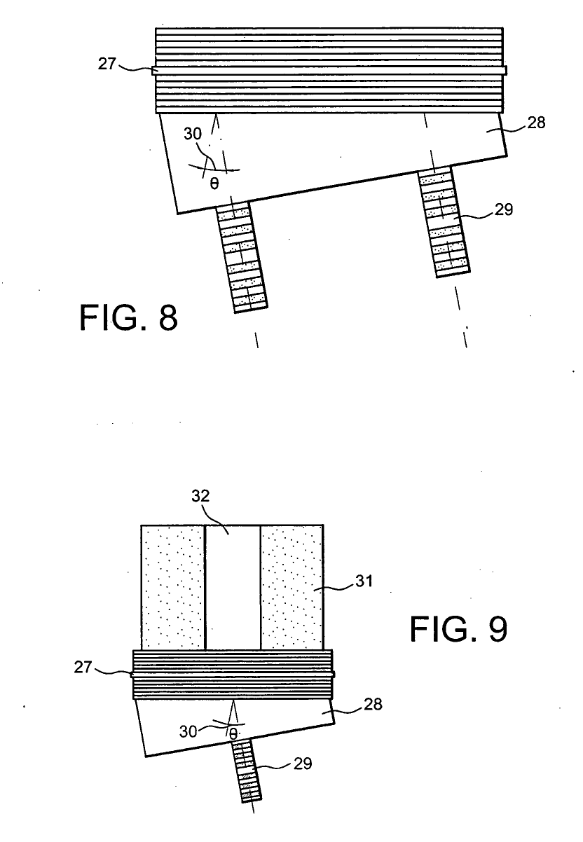

FIG. 9 shows an example of an embodiment of direct coupling of light in the core 32 of an optical fibre 31. The small size of the emission surface thus makes it possible to increase the light coupled in an optical fibre and reduce the cost of the system, by reducing the components necessary for mounting and the mounting steps.

According to the invention, an angle between the propagation of the pumping beam and the normal of the surface of the emitting microcavity is chosen.

The use of VCSEL provides additional advantages:
reduction of cost by the collective production;
increase in the optical power that can be used by a coupling in a more effective optical fibre;
reduction of the optical and mechanical components in the system.

The assemblies described in association with FIGS. 5A to 9 can be implemented in any one of the devices operating according to one of the principles described above for optimal transmission of the input mirror and optimal absorption of the pumping beam by the cavity.

The principles described (T optimiser, resonant cavity at λₚ, . . . ) are applicable to any emitting laser or non-laser cavity.

The emitting devices according to the invention preferably emit in the infrared, for example between 2 μm and 10 μm.

1-19. (canceled)

20. A device for emitting radiation by optical pumping comprising:
means for emitting light including a first resonant cavity having a first input mirror and an output mirror;
optical pumping means for emitting a pumping beam of the first cavity, the normal to the input surface of the first resonant cavity being inclined at an angle θ with respect to the direction of propagation of the pumping beam; and
means for forming a second resonant cavity for the pumping beam, said means for forming including a second input mirror forming said second cavity with the output mirror of the first cavity, and an optical element, transparent to the pumping wavelength, between the first and second input mirrors.

21. A device according to claim 20, the angle θ being such that the pumping beam is transmitted in the first cavity through the input mirror with a transmission greater than 50%.

22. A device according to claim 20, comprising Bragg or metallic mirrors.

23. A device according to claim 20, the angle θ being such that the second cavity is resonant at the wavelength of the optical pumping means.

24. A device according to claim 20, reflectivities R_{E} and R_{S} of the second input mirror and the output mirror at the wavelength of the pumping laser diode λₚ satisfying the condition:
R_{E}=R_{S} exp(−2αd/cos θ′),
where α is the absorption coefficient at the pumping wavelength, d is the absorbing thickness, and θ′ is the angle of propagation with respect to the normal, of the light in an absorbing medium.

25. A device according to claim 20, absorption of the pumping beam in the second cavity being greater than 50%.

26. A device according to claim 20, radiation emitted being emitted primarily according to the fundamental mode of the second resonant cavity.

27. A device according to claim 20, the optical pumping means comprising at least one VCSEL.

28. A device according to claim 27, the radiation beam emitted by the first resonant cavity having a diameter smaller than 200 μm.

29. A device according to claim 20, emission wavelength of the first cavity being at least partially between 2 μm and 10 μm.

30. An optical device comprising a device according to claim 20 and an optical fiber coupled to the output of the first resonant cavity.

31. A device according to claim 20, further comprising a mounting device including:
means for holding said pumping means in the mounting device;
means for holding the radiation emission device, so that the normal to the input surface of these radiation emission means is inclined at the angle θ with respect to the direction of propagation of a pumping beam coming from said optical pumping means, and including first and second surfaces, for holding said pumping means and the radiation emission device, which two surfaces form the angle θ therebetween.

32. A device according to claim 26, further comprising a mounting device including:
means for holding said pumping means in the mounting device,
means for holding a radiation emission device, so that the normal to the input surface of the radiation emission device is inclined at the angle θ with respect to the direction of propagation of a pumping beam coming from said optical pumping means, and including a growth substrate of a pumping VCSEL.

33. A device according to claim 31, the mounting device comprising a growth substrate of a pumping VCSEL.

34. A device according to claim 31, the means for holding the pumping means comprising a groove formed in the mounting device.

35. A device according to claim 34, the groove having rotational symmetry about an axis parallel to a longitudinal axis of the mounting device.

36. A device according to claim 35, an end surface of the mounting device defining a plane having a normal inclined at the angle θ with respect to the longitudinal axis.

37. A device according to claim 34, the groove being inclined at the angle θ with respect to a longitudinal axis of the mounting device.

38. A device according to claim 37, an end surface of the mounting device defining a normal plane with respect to the longitudinal axis.
